(19) United States
(12) Patent Application Publication
(10) Pub. No.: US 2018/0028027 A1
(43) Pub. Date: Feb. 1, 2018

(54) Backlit Paper Towel Dispenser

(71) Applicants: Lori Kendall, N. Richland Hills, TX (US); Lisa Jones, Shakopee, MN (US)

(72) Inventors: Lori Kendall, N. Richland Hills, TX (US); Lisa Jones, Shakopee, MN (US)

(21) Appl. No.: 15/666,457

(22) Filed: Aug. 1, 2017

Related U.S. Application Data
(60) Provisional application No. 62/369,525, filed on Aug. 1, 2016.

(51) Int. Cl. A47K 10/38; F21S 9/02; F21V 33/00; F21V 23/04

(52) U.S. Cl. CPC A47K 10/38; F21V 23/0464; F21V 23/0471; F21S 9/02; F21V 33/004; A47K 2010/389; A47K 2010/3246

(57) ABSTRACT

A paper towel dispenser includes a body and a removable, decorative panel secured to the body, and the panel includes a translucent insert. A dispenser support holds towels and secures the body to a wall. A light source is positioned within the dispenser just behind the insert. Power is supplied to the light source for illuminating the dispenser and highlighting the decorative panel. A light switch may be provided for controlling power to the light source by way of user action, a timer, ambient lighting conditions, and/or the like.

### CROSS-REFERENCE TO RELATED APPLICATIONS

This application claims the benefit of U.S. Provisional Application No. 62/369,525, filed Aug. 1, 2016, which application is hereby incorporated herein by reference, in its entirety.

### TECHNICAL FIELD

The invention relates generally to paper towel dispensers and, more particularly, paper towel dispensers having a replaceable decorative backlit panel.

### BACKGROUND

Conventionally, paper towels are dispensed in non-descript dispensers that operate in different manners and different configurations. The problem is that at night or in less-than-optimum lighting conditions it may be difficult to see the towels or the method of dispensing them in order to operate the dispenser properly.

Therefore, what is needed is a system and method for dispensing paper towels when ambient lighting renders it difficult to see or dispense the towels. Among other things, such system and method should preferably allow for the use of various decorative covers without detracting from the overall decorative effect desired.

### SUMMARY

The present invention, accordingly, provides a paper towel dispenser having an even and pleasant light source that may be turned on and off as desired, without adversely affecting the operation or decorative design of the dispenser. Accordingly, a paper towel dispenser comprises a body and one or more lights mounted on the body. A decorative panel is removably mounted on the front of the body and over the one or more lights, and at least a portion of the panel permits light to pass through. A power source is electrically coupled to the one or more lights and preferably mounted to the rear of the body. A dispenser support mountable to a wall is preferably pivotably attached to the body for partially enclosing and removably holding, within the interior thereof, paper towels for dispensing when the body is in a closed position. Preferably, means, such as a latch, is provided for securing the body to the dispenser support, and a latch release is provided for user-release of the latch.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an exemplar illuminated paper towel dispenser according to one preferred embodiment of the present invention;

FIG. 2 is a perspective view of the towel dispenser of FIG. 1, as viewed pursuant to line 2-2 of FIG. 1, with a decorative panel removed;

FIG. 3 is a rear perspective view of the body of the towel dispenser, as viewed pursuant to line 3-3 of FIGS. 1 and 2;

FIG. 4 is a rear perspective view of the decorative panel of the towel dispenser of FIG. 1;

FIG. 4A is a partially exploded view of FIG. 4;

FIG. 5 is a perspective view of an exemplar wall panel and towel support for the towel dispenser of FIG. 1, which holds the towels in the dispenser and attaches the towel dispenser to the wall;

FIG. 6 is a perspective view of the wall panel and towel support with the towel dispenser of FIG. 1 attached; and

FIG. 7 is a perspective view of an exemplar illuminated paper towel dispenser according to an alternate preferred embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

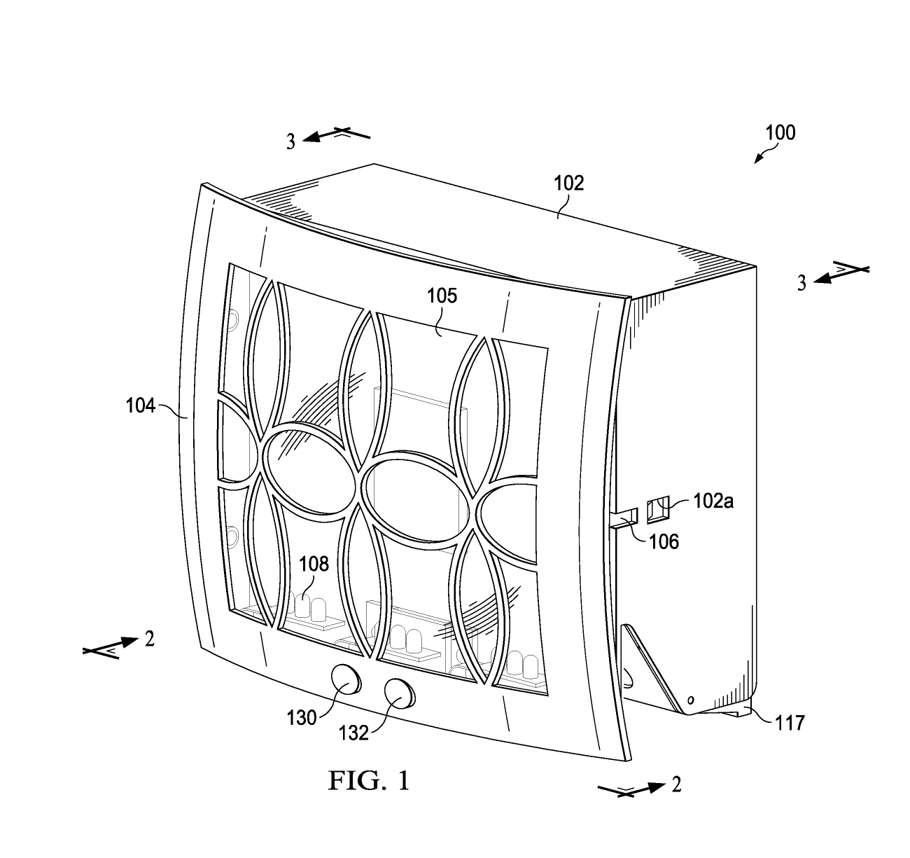

For definitional purposes, the terms “front”, “rear”, “side”, “top”, and the like, as used throughout this disclosure, are used in their normal sense in reference to directions and views shown in the accompanying Figures, and are not to be construed as absolute directions or in any way limiting to the application of this technology. More specifically, a front view is exemplified in FIG. 1 by line 2-2, and a rear view is exemplified in FIG. 1 by line 3-3.

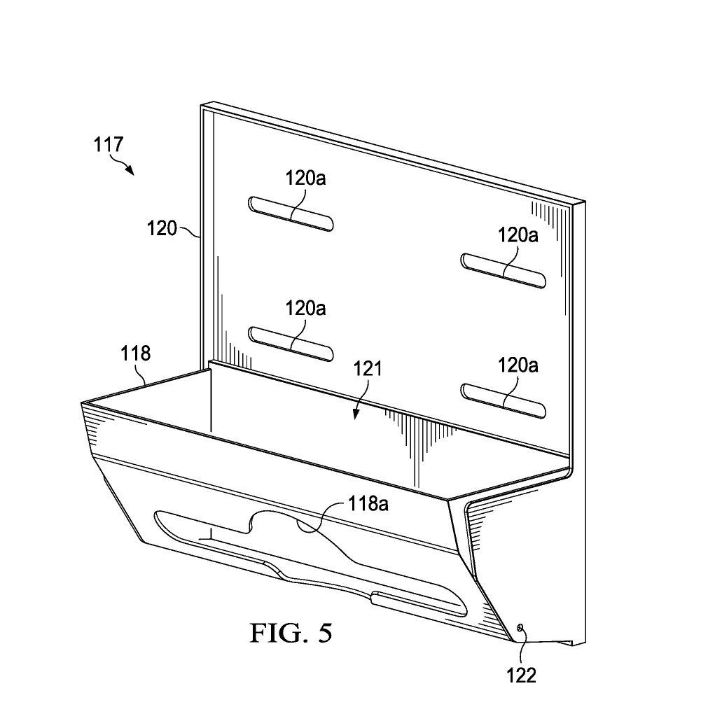

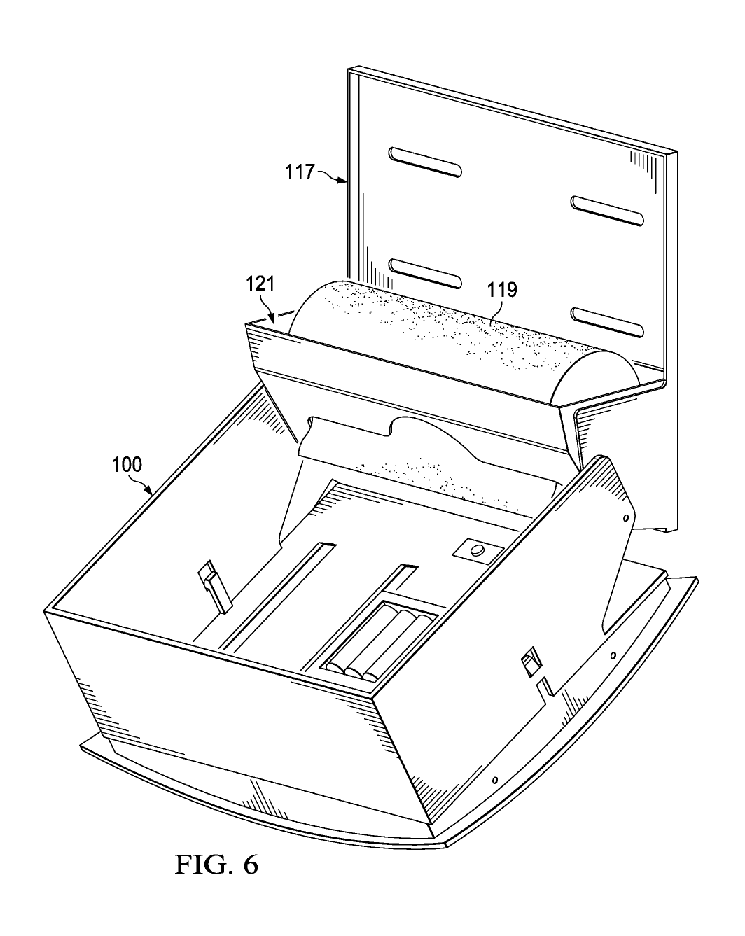

Referring to FIG. 1 of the drawings, the reference numeral 100 generally designates an illuminated paper towel dispenser embodying features of the present invention. Towel dispenser 100 includes a body 102 and a decorative panel 104 that is preferably replaceable and removably mounted on the front of the body. Decorative panel 104 is configured to add an attractive appearance to towel dispenser 100 and to be replaceable with other decorative panels. Decorative panel 104 preferably contains an insert 105 which is preferably a sheet of material, such as plastic, which is transluscent, transparent or semi-transparent, providing a controlled interior view as well as allowing the interior lighting to serve as a night-light or other lighting feature. Reference numeral 117 represents a portion of a dispenser support to which body 102 is pivotably attached, as discussed in further detail below with respect to FIGS. 5 and 6.

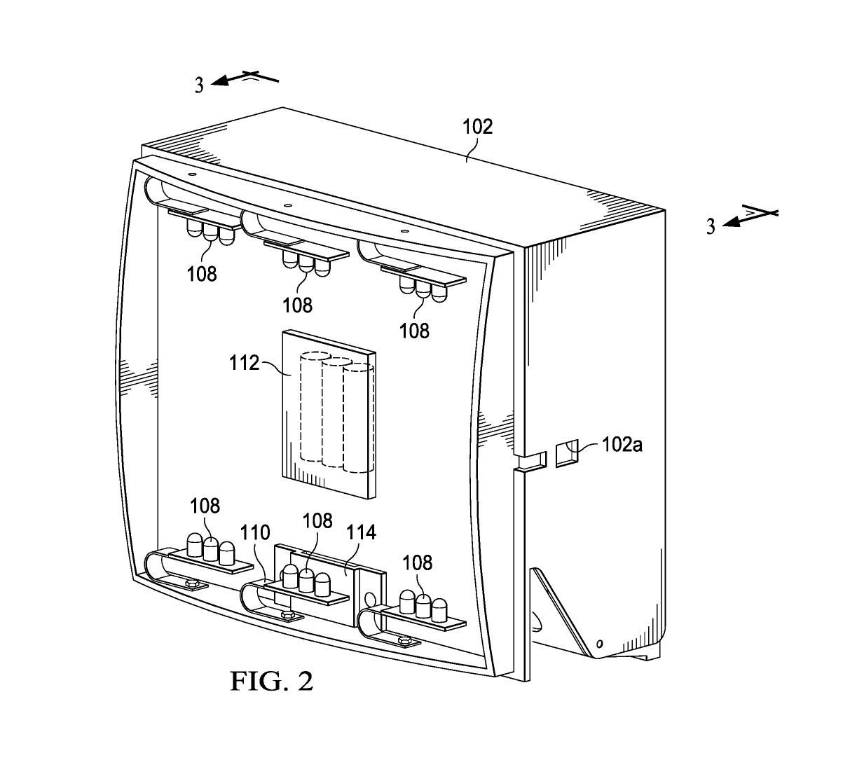

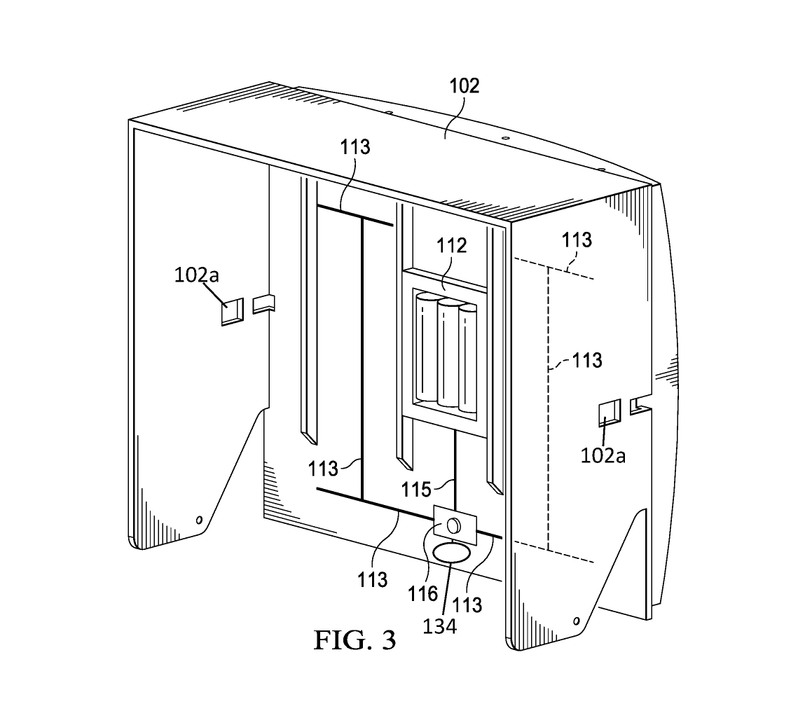

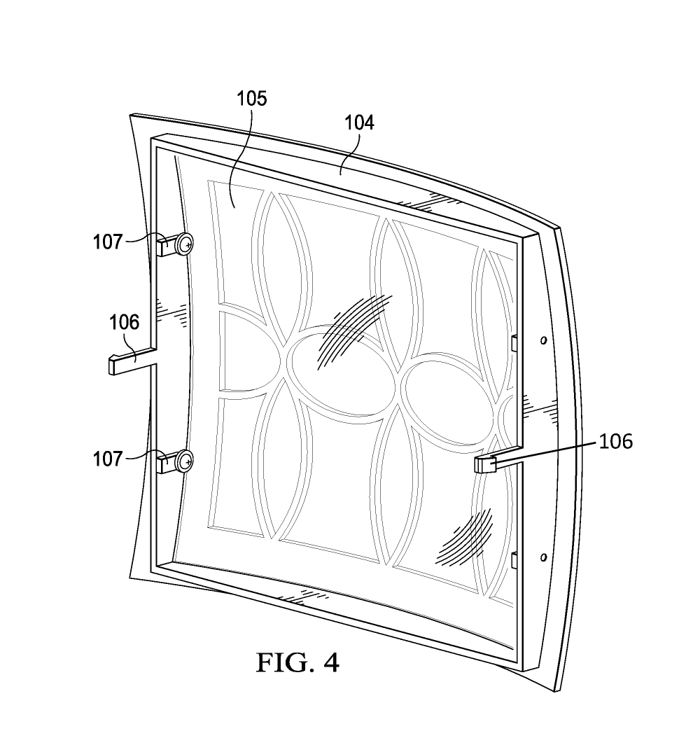

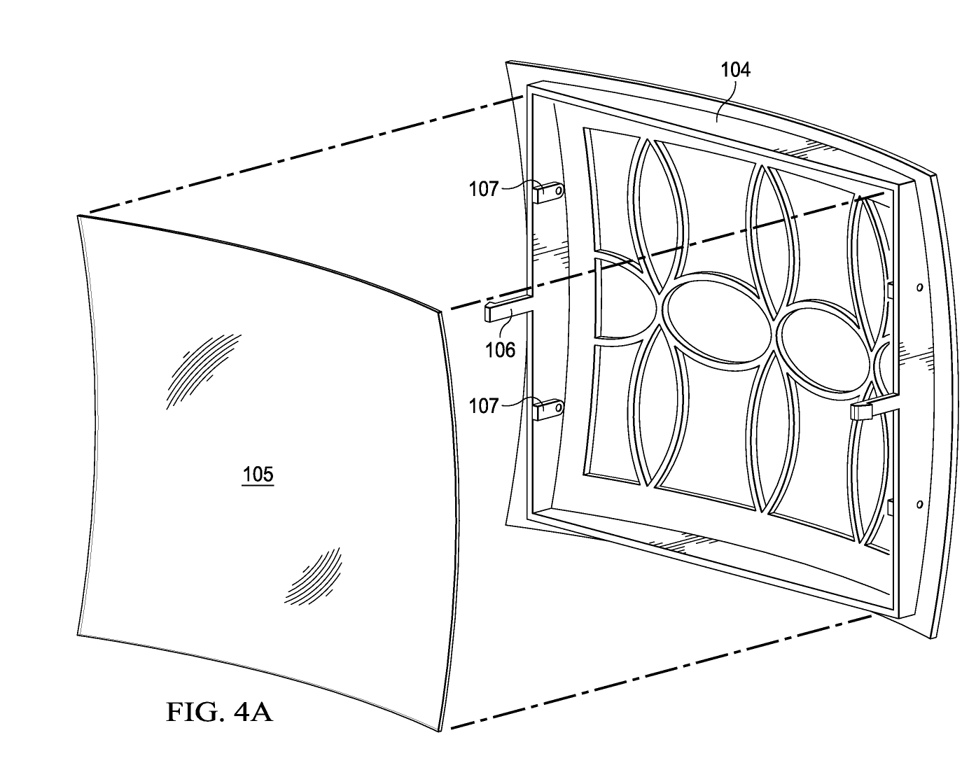

Towel dispenser 100 further incorporates interior illumination as described in further detail below. Decorative panel 104 preferably includes latches 106 (see also FIG. 4), and body 102 defines corresponding latch holes 102a (see also FIG. 3) for receiving latches 106 to secure decorative panel 104 to body 102. As shown more clearly in FIG. 2, body 102 contains lights 108, preferably positioned on upper and lower portions of body 102, to provide illumination. Lights 108 may be any light source, such as, by way of example but not limitation, light emitting diodes (“LEDs”), fluorescent lights (including compact fluorescent lamps), incandescent bulbs, and the like. Towel dispenser 100 and portions thereof may be fabricated from any suitable material, such as plastic, or the like.

FIG. 2 shows a front perspective view of body 102, as viewed pursuant to line 2-2 of FIG. 1, with decorative panel 104 removed to exemplify the placement of upper and lower lights 108 by means of adjustable light brackets 110. A power source 112 is preferably attached to the front side of body 102 for providing access, on the rear side of the body, as shown in FIG. 3, to the power source. Power source 112 may comprise, by way of example but not limitation, one or more batteries, or a power converter that receives alternating current (AC) and converts the AC to a form of electrical power usable by the lights. A light switch cover 114 is optionally attached to the front of body 102 for providing access, on the rear side of the body as shown in FIG. 3, to light switch 116.

FIG. 3 shows a rear perspective view of body 102, as viewed pursuant to line 3-3 of FIGS. 1 and 2. FIG. 3 exemplifies how power source 112 may be configured as a housing for holding batteries which may be readily accessed. Power, as electrical current, is conducted via lines 115 to a light switch 116 which is preferably also attached to the back side of body 102 for controlling power from power source 112 via lines 113 to lights 108 (FIG. 2). Alternatively, light switch 116 may be activated (i.e., turned on) by a timer 134, an ambient light sensor 130 (FIG. 1) which activates the switch when light falls below a predetermined level, and/or a motion detector 132 (FIG. 1) which activates the light switch when motion is detected proximate to the dispenser (electrical wiring coupling ambient light sensor 130 and motion detector 132 to switch 116 is not shown, as it is considered to be understood by a person skilled in the art). Still further, light switch 116 could be operative as a rheostat to provide variable brightness levels. Light switch 116 may also incorporate a processor to control activation of the light switch based on any combination of factors, such as time, ambient light, motion, and the like.

FIG. 4 shows a rear perspective view of decorative panel 104 and insert 105, together with latches 106, which clip into latch holes 102a to secure decorative panel 104 to body 102. Fasteners, such as screw-and-washer retainers 107 are preferably used to secure insert 105 to decorative panel 104, although it is contemplated that any number of techniques could be used to the same end. FIG. 4A is an exploded view showing insert 105 apart from panel 104. Alternatively, insert 105 may be secured to panel 104 using adhesive or any conventional technique well-known to those skilled in the art to join together or integrate panel 104 and insert 105.

FIG. 5 is a perspective view exemplifying dispenser support 117 for mounting towel dispenser 100 to a wall. Dispenser support 117 is exemplified as comprising a towel support 118 configured to hold towels 119 (FIG. 6) in towel dispenser 100. Towel support 118 preferably includes a wall panel 120 for securing towel support 118 to a wall. Wall panel 120 preferably defines slots such as slots 120a through which fasteners, such as screws (not shown), may be passed into a wall, or which may be used to hang the dispenser on hooks. Means such as pins or rivets 122 are provided for pivotably connecting body 102 to towel support 118. Towel support 118 includes a receiver 121 for holding and dispensing through an opening 118a flat paper towels, rolled paper towels, or the like. It is contemplated that dispenser support 117 may alternatively be formed by integrating wall panel 120 and towel support 118 as a single unit.

FIG. 6 shows body 102 of towel dispenser 100 attached via rivets 122 to towel support 118, and as opened for towel or power source replacement. Receiver 121 is exemplified with a roll of paper towels 119 positioned in receiver 121.

In operation, wall panel 120 with towel support 118 is mounted to a wall, paper towel dispenser 100 is mounted on the towel support, and power source 112 is made ready for supplying power, such as by being provided with fresh batteries. Paper towels 119 are loaded into receiver 121 with a first paper towel extending through opening 118a. Switch 116 is then activated for supplying electrical power from power source 112 to lights 108. Switch 116 may optionally be activated by user action, a timer, and/or ambient light conditions. Switch 116 preferably also allows for varying the lumens emitted from lights 108. Power source or paper towels may be replenished by opening body 102 as shown in FIG. 6, discussed above.

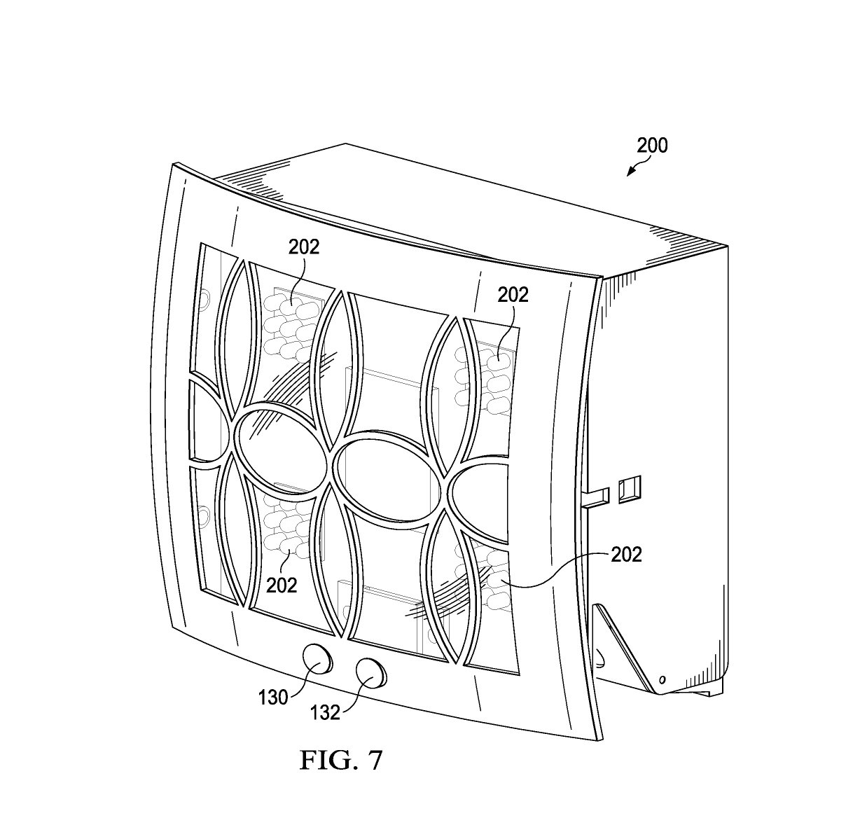

FIG. 7 shows a perspective view of an illuminated paper towel dispenser 200 according to an alternate preferred embodiment of the present invention. This embodiment is substantially similar to the embodiment of FIGS. 1-6, but for the positioning of lights 108 as indicated by reference numeral 202 on the front side of body 102 directly behind insert 105, thereby providing more direct illumination than with the placement of lights 108 as depicted in FIGS. 1 and 2. Operation of the paper towel dispenser of FIG. 7 is substantially similar to operation of the dispenser of FIGS. 1-6.

The use of the present invention provides a number of advantages over the prior art. For example, efficient and pleasant lighting is provided that is not excessive and that is well-placed. The light panel cannot disrupt the operation of the dispenser, including towel replenishment, power source replacement, and decorative panel replacement.

Such systems and methods should, among other things, allow for the use of various decorative covers without obstructing the light or causing undesirable visual effects or otherwise detracting from the overall decorative effect desired.

It is understood that the present invention may take many forms and embodiments. Accordingly, several variations may be made in the foregoing without departing from the spirit or the scope of the invention. For example, the lights may be powered from a power outlet in a home. Ambient light sensor 130 and motion detector 132 may be positioned behind the decorative panel, on the panel shown in FIG. 2, for example, proximate power source 112.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A paper towel dispenser comprising:
a dispenser support mountable to a wall for partially enclosing and removably holding paper towels for dispensing;
a body pivotably attached to the dispenser support, the body having a front side, a rear side opposing the front side, and an interior portion interposed between the front side and the rear side;
one or more lights mounted on the body and configured for generating illumination;
a panel removably mounted on the front side of the body and over the one or more lights configured so that at least a portion of illumination may pass through the panel; and
a power source electrically coupled to the one or more lights.

2. The dispenser of claim 1 wherein the lights are light emitting diodes (“LEDs”).

3. The dispenser of claim 1 wherein the lights are fluorescent lights.

4. The dispenser of claim 1 wherein the lights are incandescent bulbs.

5. The dispenser of claim 1 further comprising a light switch operably coupled between the light and power source for controlling power to the light source.

6. The dispenser of claim 1 further comprising:
a light switch operably coupled between the light and power source for controlling power to the light source; and
a timer operably coupled to the light switch for controlling the light switch.

7. The dispenser of claim 1 further comprising:
a light switch operably coupled between the light and power source for controlling power to the light source; and
an ambient light sensor operably coupled to the light switch for activating the light switch when ambient light is less than a predetermined value.

8. The dispenser of claim 1 further comprising:
a light switch operably coupled between the light and power source for controlling power to the light source; and
a motion detector operably coupled to the light switch for activating the light switch when motion is detected proximate to the dispenser.

9. The dispenser of claim 1 wherein the dispenser support comprises:
a wall panel; and
a towel support attached to the wall panel.

10. The dispenser of claim 1 wherein the power source is mounted to the rear side of the body.

11. The dispenser of claim 1 wherein the power source comprises one or more batteries electrically coupled to the one or more lights via the switch.

12. The dispenser of claim 1 wherein the power source comprises a power converter electrically coupled to the one or more lights via the switch, wherein the power converter receives alternating current and converts it for use with the one or more lights.

13. The dispenser of claim 1 further comprising a latch configured for securing the body to the dispenser support.
